(19) United States
(12) Patent Application Publication
(10) Pub. No.: US 2017/0193145 A1
(43) Pub. Date: Jul. 6, 2017

(54) SELECTION OF AN EQUIVALENT 1D ELEMENT TYPE IN A DESTINATION FEA TOOL FOR 1D ELEMENTS IN A SOURCE FEA TOOL

(71) Applicants: AIRBUS GROUP INDIA PRIVATE LIMITED, Bangalore (IN); AIRBUS OPERATIONS S.L., Getafe (ES)

(72) Inventors: SOHAM NARAYAN PATEL, Bangalore (IN); AMIT CHAUDHARI, Bangalore (IN); ABHISHEK DWIVEDI, Bangalore (IN); JORGE GONZALEZ-RUBIO, Getafe (ES)

(21) Appl. No.: 15/313,577

(22) PCT Filed: May 25, 2015
(86) PCT No.: PCT/IN2015/000221

§ 371 Date: Nov. 23, 2016

(30) Foreign Application Priority Data
May 23, 2014 (IN) 2578/CHE/2014

(51) Int. Cl. G06F 17/50; B64F 5/00

(52) U.S. Cl. CPC G06F 17/5018; G06F 17/5095; B64F 5/00

(57) ABSTRACT

A system and method for selection of an equivalent one dimension (1D) element type in a finite element model (FEM) of a destination finite element analysis (FEA) tool for 1D elements in a FEM of a source FEA tool are disclosed. In one embodiment, 1D elements in the FEM of the source FEA tool are selected based on associated physical behavioral features. Further, shear stiffness factors associated with each selected 1D element in the FEM of the source FEA tool are extracted. Furthermore, the equivalent 1D element type in the FEM of the destination FEA tool is selected for each selected 1D element in the FEM of the source FEA tool based on the extracted shear stiffness factors for performing FEA.

### RELATED APPLICATIONS

Benefit is claimed under 35 U.S.C. 119(a)-(d) to International Patent Application No. PCT/IN2015/000221 filed on May 25, 2015, entitled “SELECTION OF AN EQUIVALENT 1D ELEMENT TYPE IN A DESTINATION FEA TOOL FOR 1D ELEMENTS IN A SOURCE FEA TOOL” and to Indian Application Number 2578/CHE/2014 filed on May 23, 2014, entitled “SELECTION OF AN EQUIVALENT 1D ELEMENT TYPE IN A DESTINATION FEA TOOL FOR 1D ELEMENTS IN A SOURCE FEA TOOL” by AIRBUS GROUP INDIA PRIVATE LIMITED and AIRBUS OPERATIONS S.L. which is herein incorporated in its entirety by reference for all purposes.

### TECHNICAL FIELD

Embodiments of the present subject matter generally relate to finite element analysis (FEA), and more particularly, to selection of an equivalent one dimension (1D) element type in a destination FEA tool corresponding to each 1D element in a source FEA tool for performing FEA.

### BACKGROUND

Typically, more than one finite element analysis (FEA) tool is used in performing an analysis of a structure. For example, in structural analysis of aircraft structures, one FEA tool is used for linear analysis and another FEA tool is used for non-linear analysis. Typically, depending on size of the structure and analysis to be performed, it may take several hours to years in building a finite element model (FEM) based on the FEA tool. It may be envisioned that the redundant task of rebuilding the FEM from scratch for other FEA tools may be time consuming and typically, to overcome this, commercially available finite element translators provided by tool providers are used.

These finite element translators may accurately translate two dimension (2D) and 3D elements, loads, constraints, coordinate systems and so on in the structure. However, translating 1D elements using these finite element translators may result in errors. For example, errors include faulty translation of transverse shear stiffness, swapping cross-sectional (C/S) properties like moment of inertia about an elemental axis, failing to convert neutral axis (NA) offset with reference to a shear centre (SC), failing to select correct element type in a destination FEA tool and so on.

In one example, a source FEA tool, such as Nastran™, may define a 1D element with varying C/S area (i.e., a tapered beam) and a destination FEA tool, such as Abaquse, may not define the 1D element with varying C/S area. In such a situation, existing finite element translators may translate the tapered beam as a uniform beam. In another example, for capturing correct stiffness of a FEM, 1D elements may be modeled by considering some C/S properties of the 1D elements as zero or unrealistic. Therefore, such translations may cause non-convergence in the non-linear analysis.

### SUMMARY

A system and method for selection of an equivalent one dimension (1D) element type in a destination finite element analysis (FEA) tool for 1D elements of a source FEA tool are disclosed. According to one aspect of the present subject matter, 1D elements in a finite element model (FEM) of the source FEA tool are selected based on associated physical behavioral features. Further, shear stiffness factors associated with each selected 1D element in the FEM of the source FEA tool are extracted. Furthermore, the equivalent 1D element type is selected in a FEM of the destination FEA tool corresponding to each selected 1D element in the FEM of the source FEA tool based on the extracted shear stiffness factors. In addition, each selected 1D element in the FEM of the source FEA tool is converted to the FEM of the destination FEA tool using the selected equivalent 1D element type corresponding to each selected 1D element for performing FEA.

According to another aspect of the present subject matter, the system includes a processor and a memory coupled to the processor. Further, the memory includes the source FEA tool, the destination FEA tool, and a selection module. In one embodiment, the selection module selects the equivalent 1D element type in the destination FEA tool corresponding to each 1D element in the FEM of the source FEA tool for performing FEA using the method described above.

According to yet another aspect of the present subject matter, a non-transitory computer-readable storage medium for selection of an equivalent 1D element type in a destination FEA tool for 1D elements of a source FEA tool, having instructions that, when executed by a computing device causes the computing device to perform the method described above.

The system and method disclosed herein may be implemented in any means for achieving various aspects. Other features will be apparent from the accompanying drawings and from the detailed description that follow.

### BRIEF DESCRIPTION OF THE DRAWINGS

Various embodiments are described herein with reference to the drawings, wherein:

FIG. 1 is a flow diagram depicting an example method for selecting an equivalent one dimension (1D) element type in a destination finite element analysis (FEA) tool corresponding to each 1D element of a source FEA tool;

FIG. 2 is a table showing example types of 1D element in a source FEA tool;

FIG. 3 is a table showing example 1D element types in a destination FEA tool;

FIG. 4 illustrates a schematic diagram of an example beam to find shear stiffness factors;

FIG. 5 is another flow diagram depicting an example method for selecting an equivalent 1D element type in a destination FEA tool corresponding to each 10D element of a source FEA tool; and

FIG. 6 illustrates a block diagram of an example computing system including a selection module for selecting an equivalent 1D element type in a destination FEA tool corresponding to each 1D element of a source FEA tool, using the processes described with reference to FIGS. 1 and 5.

The drawings described herein are for illustration purposes only and are not intended to limit the scope of the present disclosure in any way.

### DETAILED DESCRIPTION

A system and method for an equivalent one dimension (1D) element type in a destination finite element analysis (FEA) tool for 1D elements in a source finite element analysis (FEA) tool are disclosed. In the following detailed description of the embodiments of the present subject matter, references are made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

The terms “converting” and “translating” are used interchangeably throughout the document.

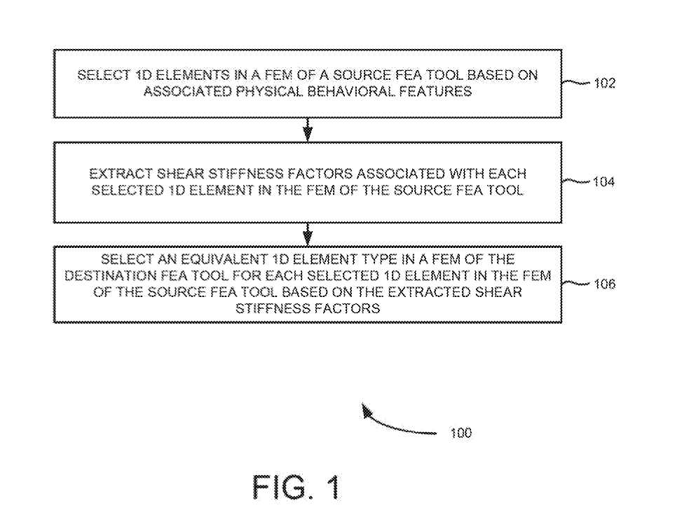

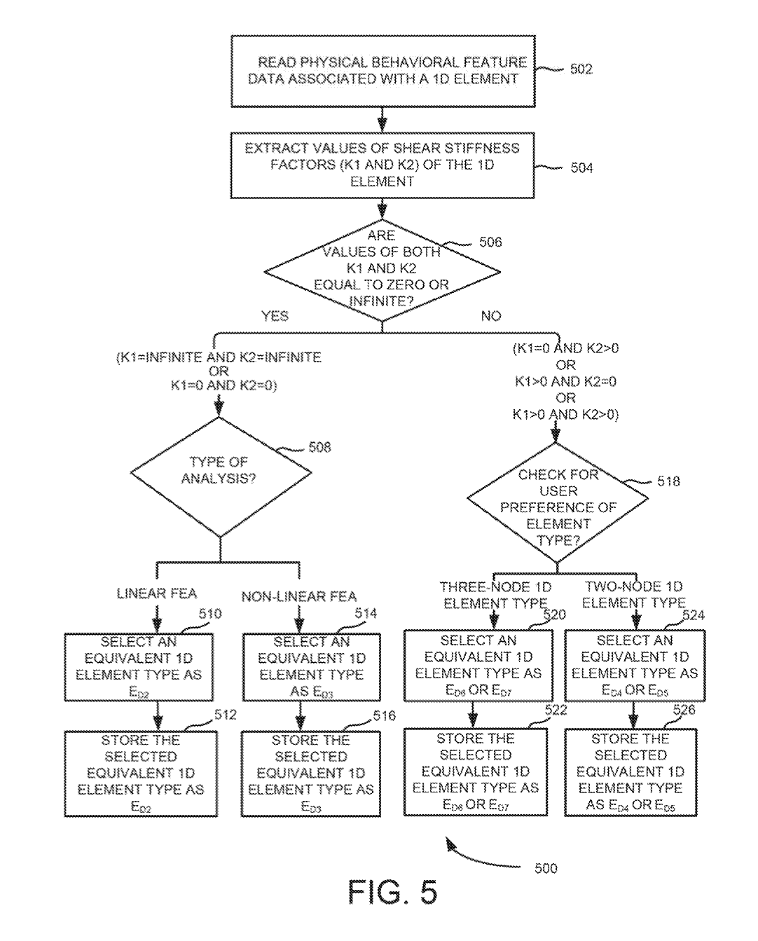

FIG. 1 illustrates a flow diagram 100 of an example method for selecting an equivalent 1D element type in a destination FEA tool corresponding to each 1D element of a source FEA tool. At step 102, 1D elements in a finite element model (FEM) of the source FEA tool are selected based on associated physical behavioral features. In one embodiment, a type of 1D element is selected for each 1D element in the FEM of the source FEA tool based on the physical behavioral features associated with each 1D element. In other words, each 1D element in the FEM of the source FEA tool is identified as one of three types, such as E_{S1}, E_{S2} or E_{S3}, based on the various physical behavioral features. This is explained in more detail with reference to FIG. 5. Example physical behavioral features include axial stiffness, torsional stiffness, bending stiffness, transverse shear stiffness, a shear centre (SC) offset, a neutral axis (NA) offset, warping, stress recovery, variable cross-sectional (C/S) properties along length, release translational degree of freedom (DOF) at end nodes of a 1D element, release rotational DOF at end nodes of a 1D element, a number of nodes in a 1D element and the like. Further in this embodiment, 1D elements of types E_{S2} and E_{S3} having various physical behavioral features are selected. In this embodiment, the 1D elements of type E_{S1} have only axial stiffness and torsional stiffness. At step 104, shear stiffness factors associated with each selected 1D element in the FEM of the source FEA tool are extracted. At step 106, the equivalent 1D element type is selected in a FEM of the destination FEA tool for each selected 1D element in the FEM of the source FEA tool based on the extracted shear stiffness factors. This is explained in more detail with reference to FIG. 5. In addition, each selected 1D element in the FEM of the source FEA tool is converted to the FEM of the destination FEA tool using the selected equivalent 1D element type corresponding to each selected 1D element for performing FEA.

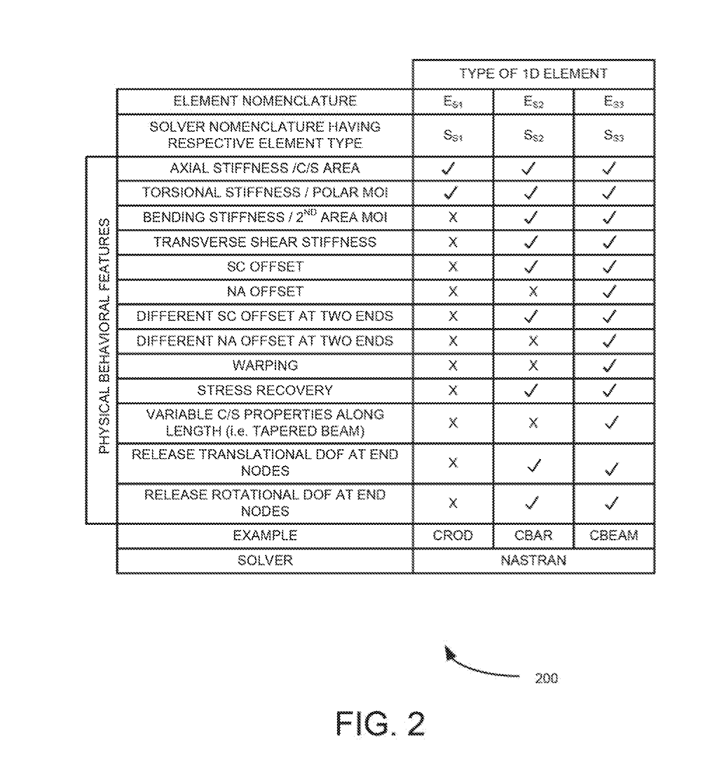

Referring now to FIG. 5, which is a flow diagram 500 illustrating detailed process for selecting an equivalent 1D element type in a destination FEA tool corresponding to each 1D element in a FEM of a source FEA tool. For example, a source FEA tool can be Nastran™ and a destination FEA tool can be Abaqus®. In one embodiment, the 1D elements of the source FEA tool are classified into various types, such as E_{S1}, E_{S2} or E_{S3} based on physical behavioral features. Example physical behavioral features include axial stiffness, torsional stiffness, bending stiffness, transverse shear stiffness, a SC offset, a NA offset, warping, stress recovery, variable C/S properties along length, release translational DOF at end nodes of a 1D element, release rotational DOF at end nodes of a 1D element, a number of nodes and the like. In the example illustrated in FIG. 2, a table 200 shows types of 1D elements available in the source FEA tool. Specified in the last two rows of the table 200 is the example of each type of 1D element found in commercially available tool, like Nastran™. For example, if Nastran™ is considered as the source FEA tool, then CROD element is E_{S1}, CBAR is E_{S2} and CBEAM is E_{S3}.

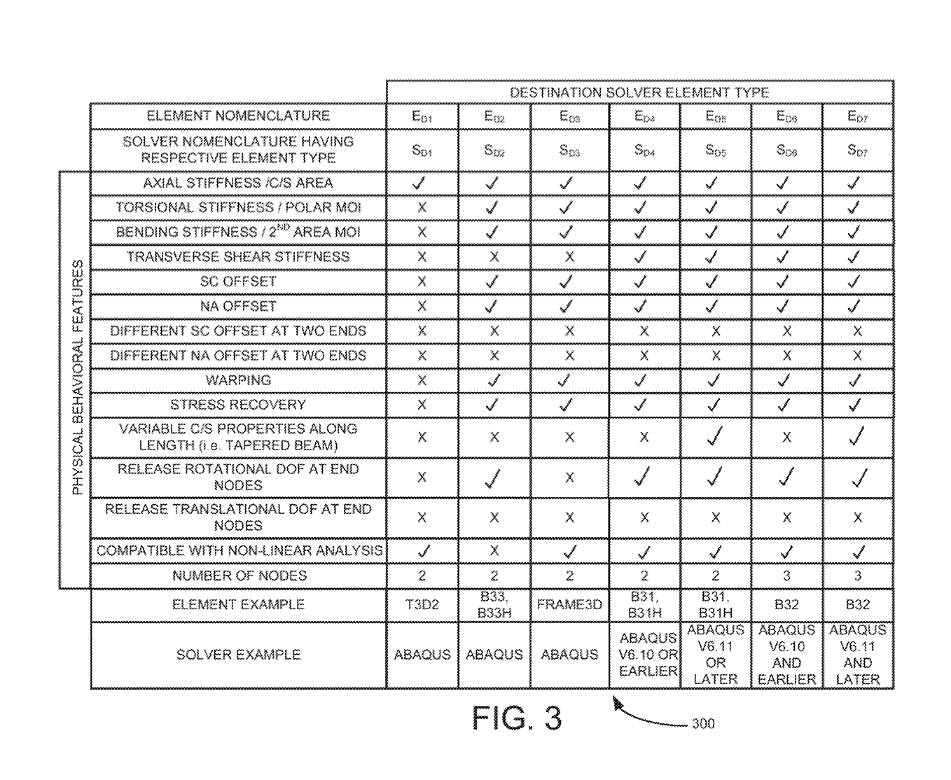

Further, 1D elements in the destination FEA tool are classified into various elements types, such as E_{D1}, E_{D2}, E_{D3}, E_{D4}, E_{D5}, E_{D6}, and E_{D7} based on the physical behavioral features. In the example illustrated in FIG. 3, a table 300 shows the 1D element types available in the destination FEA tool. Specified in the last two rows of the table 300 is the example of each 1D element type found in commercially available tool, like Abaqus®. For example, if Abaqus v6.10 or earlier are considered as the destination FEA tool, then T3D2 is E_{D1}, B33 or B33H is E_{D2}, FRAME3D is E_{D3}, B31 or B31H is E_{D4} and B32 is E_{D6}. If one considers Abaqus v6.11 and later as the destination FEA tool, then T3D2 is E_{D1}, B31 or B31H is E_{D5} and B32 is E_{D7}.

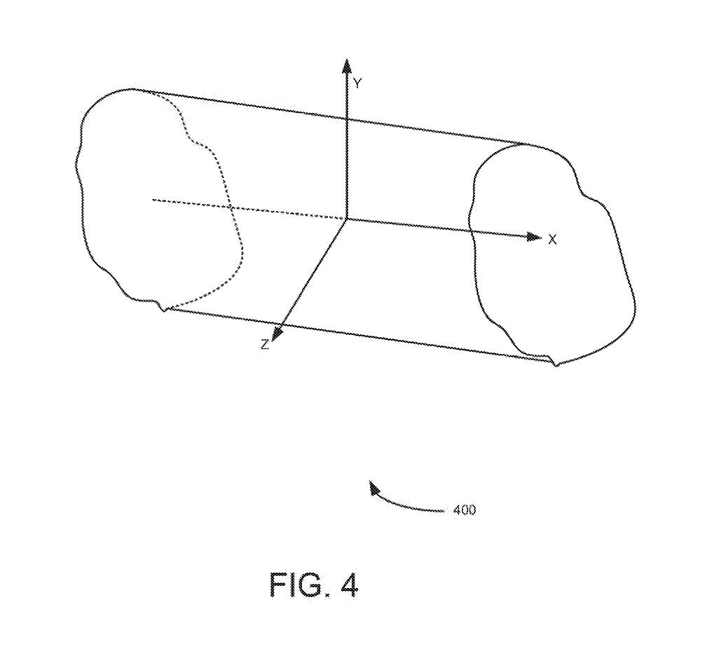

At step 502, physical behavioral feature data associated with a 1D element (which may be of type E_{S2} or E_{S3}) in the source FEA tool is read from an input deck of the associated 1D element. For example, the physical behavioral feature data includes data associated with the physical behavioral features of the 1D element. At step 504, values of shear stiffness factors associated with the 1D element are extracted using the physical behavioral feature data. For example, a first shear stiffness factor (K1) associated with the 1D element is extracted corresponding to an XY plane and a second shear stiffness factor (K2) associated with the 1D element is extracted corresponding to an XZ plane. The shear stiffness factors K1 and K2 ranges from zero to infinity. In the example illustrated in FIG. 4, values of K1 and K2 of a beam, shown in a schematic diagram 400, are extracted based on bending of the beam caused due to application of force. In one example, the shear stiffness factor K1 associated with the beam is extracted when the beam bends in the XY plane. Further, the shear stiffness factor K2 associated with the beam is extracted when the beam bends in the XZ plane.

In one embodiment, the values of K1 and K2 determine value of transverse shear stiffness. The transverse shear stiffness can be expressed using an equation:

K_{S1}=K1AG (1)

K_{S2}=K2AG (2)

wherein,

K_{S1}, K_{S2}=transverse shear stiffness,

K1 and K2=shear stiffness factors,

A=C/S area, and

G=shear modulus.

In equation (1), the values of K_{S1} and K_{S2} depend on the values of K1 and K2, respectively. For example, the values of K_{S1} and K_{S2} are equal to zero or infinity when the values of both K1 and K2 are equal to zero or infinite, respectively, and the values of K_{S1} and/or K_{S2} are not equal to zero when the values of K1 and/or K2 are not equal to zero or infinite, respectively, as values of A and G in equations (1) and (2) cannot be zero.

At step 506, a check is made to determine whether the values of K1 and K2 are simultaneously equal to zero or infinite. If the values of both K1 and K2 are simultaneously equal to zero or infinite, a user is allowed to select a type of FEA to be performed in the destination FEA tool at step 508. For example, the type of the FEA to be performed in the destination FEA tool includes a linear FEA or a non-linear FEA. In one embodiment, if the values of both K1 and K2 are simultaneously equal to zero or infinite, it implies that the values of K_{S1} and K_{S2} obtained using equations (1) and (2), respectively, are zero or infinite and the 1D element has no transverse shear stiffness, indicating it is based on Euler-Bemoulli bending theory. In this case, a set of 1D element types having no transverse shear stiffness is selected in the destination FEA tool. For example, the 1D element types having no transverse shear stiffness in the destination FEA tool are E_{D2} and E_{D3} (as shown in FIG. 3). Further, the user is allowed to select the type of FEA to be performed in the destination FEA tool.

When the user selects the linear FEA to be performed in the destination FEA tool, an equivalent 1D element type compatible with linear analysis is selected in the destination FEA tool from the set of 1D element types having no transverse shear stiffness at step 510. For example, the equivalent 1D element type in the destination FEA tool is selected as E_{D2} when the user selects that the type of FEA to be performed in the destination FEA tool is the linear FEA. At step 512, the selected equivalent 1D element type (i.e., E_{D2}) in the destination FEA tool is stored.

When the user selects the non-linear FEA to be performed in the destination FEA tool, an equivalent 1D element type compatible with non-linear analysis is selected from the set of 10D element types having no transverse shear stiffness in the destination FEA tool at step 514. For example, the equivalent 1D element type in the destination FEA tool is selected as E_{D3} when the user selects that the type of FEA to be performed in the destination FEA tool is the non-linear FEA. At step 516, the selected equivalent 1D element type (i.e., E_{D3}) in the destination FEA tool is stored.

If the values of K1 and/or K2 are greater than or equal to zero (i.e., K1 is greater than zero and K2 is equal to zero or K1 is equal to zero and K2 is greater than zero or K1 and K2 both are greater than zero), the user is allowed to select a preference for the equivalent 1D element type in the destination FEA tool at step 518. For example, the preference for the equivalent 1D element type in the destination FEA tool includes a two-node 10D element type, a three-node 1D element type and the like.

In one embodiment, if K1 and/or K2 are greater than zero, it implies that the values of K_{S1} and/or K_{S2} obtained using equations (1) and (2), respectively, are not zero and the 1D element has transverse shear stiffness. In this case, a set of 1D element types having transverse shear stiffness is selected in the destination FEA tool. For example, the 1D element types having transverse shear stiffness in the destination FEA tool are E_{D4}, E_{D5}, E_{D6} and E_{D7} (as shown in FIG. 3). Further, the user is allowed to select the preference for the equivalent 1D element type in the destination FEA tool.

When the user selects the preference as the three-node 1D element type, an equivalent 1D element type having three nodes is selected from the set of 1D element types having transverse shear stiffness at step 520. For example, the equivalent 1D element type in the destination FEA tool is selected as E_{D6} or E_{D7} when the user selects the preference for the equivalent 1D element type as the three-node 1D element type. Further, the selection of equivalent 1D element type as E_{D6} or E_{D7} is based on a user preference for a solver in the destination FEA tool. In one example implementation, the user is allowed to select a preference for the solver in the destination FEA tool. Further, the equivalent 1D element type is selected as E_{D6} when the selected preference for the solver in the destination FEA tool is Abaqus v6.10 or earlier. Furthermore, the equivalent 1D element type is selected as E_{D7} when the selected preference for the solver in the destination FEA tool is Abaqus v6.11 or later. At step 522, the selected equivalent 1D element type (e.g., E_{D6} or E_{D7}) is stored.

When the user selects the preference for the equivalent 1D element type as the two-node 1D element type, an equivalent 1D element type having two nodes is selected from the set of 1D element types having transverse shear stiffness at step 524. For example, the equivalent 1D element type is selected as E_{D4} or E_{D5} when the user selects the preference for the equivalent 1D element type as the two-node 1D element type. In this example, the selection of equivalent 1D element type as E_{D4} or E_{D5} is based on user preference for the solver in the destination FEA tool. In one example implementation, the equivalent 1D element type is selected as E_{D4} when the user preference for solver in the destination FEA tool is Abaqus v6.10 or earlier. Further, the equivalent 1D element type is selected as Eoswhen the user preference for solver in the destination FEA tool is Abaqus v6.11 or later. At step 526, the selected equivalent 1D element type (e.g., E_{D4} or E_{D5}) is stored. Further, the steps 502 to 526 are repeated for next 1D element in the FEM of the source FEA tool until the selection of the equivalent 1D element type in the destination FEA tool corresponding to all 1D elements in the FEM of the source FEA tool is completed.

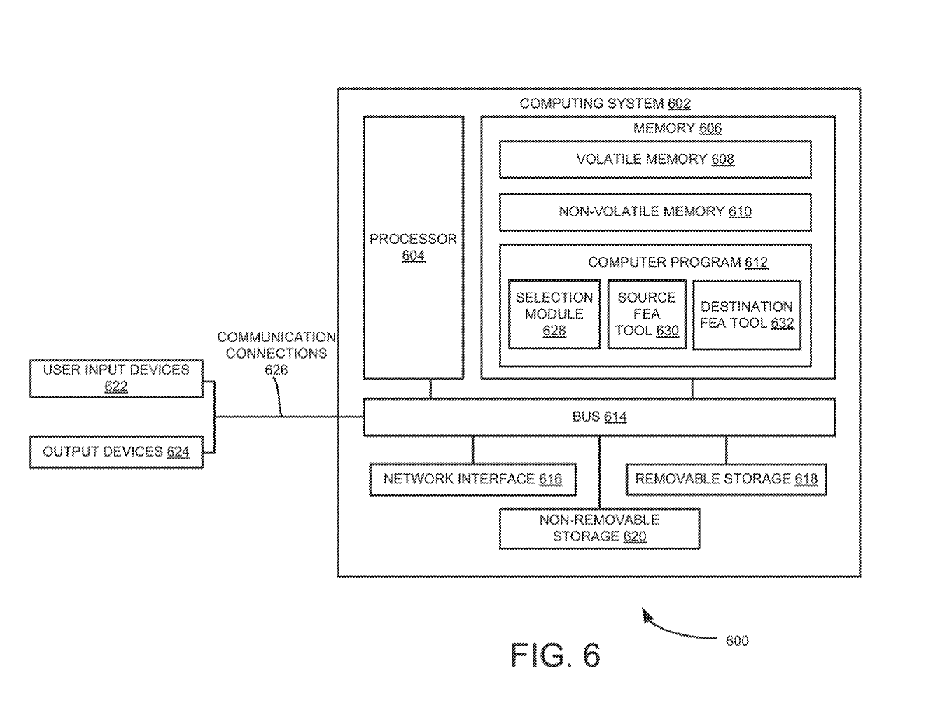

Referring now to FIG. 6, which illustrates an example computing system 602 including a selection module 628 for selecting an equivalent 1D element type in a destination FEA tool 630 corresponding to each 1D element of a source FEA tool 632, using the processes described with reference to FIGS. 1 and 5. FIG. 6 and the following discussions are intended to provide a brief, general description of a suitable computing environment in which certain embodiments of the inventive concepts contained herein are implemented.

The computing system 602 includes a processor 604, memory 606, a removable storage 618, and a non-removable storage 620. The computing system 602 additionally includes a bus 614 and a network interface 616. As shown in FIG. 6, the computing system 602 includes access to the computing system environment 600 that includes one or more user input devices 622, one or more output devices 624, and one or more communication connections 626 such as a network interface card and/or a universal serial bus connection.

Exemplary user input devices 622 include a digitizer screen, a stylus, a trackball, a keyboard, a keypad, a mouse and the like. Exemplary output devices 624 include a display unit of the personal computer, a mobile device, and the like. Exemplary communication connections 626 include a local area network, a wide area network, and/or other network.

The memory 606 further includes volatile memory 608 and non-volatile memory 610. A variety of computer-readable storage media are stored in and accessed from the memory elements of the computing system 602, such as the volatile memory 608 and the non-volatile memory 610, the removable storage 618 and the non-removable storage 620. The memory elements include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, Memory Sticks™, and the like.

The processor 604, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 604 also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, and application programs, for performing tasks, or defining abstract data types or low-level hardware contexts. Machine-readable instructions stored on any of the above-mentioned storage media may be executable by the processor 604 of the computing system 602. For example, a computer program 612 includes machine-readable instructions capable for selecting the equivalent 1D element type in a FEM of the destination FEA tool 630 corresponding to each 1D element in a FEM of the source FEA tool 632 in the computing system 602, according to the teachings and herein described embodiments of the present subject matter. In one embodiment, the computer program 612 is included on a compact disk-read only memory (CD-ROM) and loaded from the CD-ROM to a hard drive in the non-volatile memory 610. The machine-readable instructions cause the computing system 602 to encode according to the various embodiments of the present subject matter.

As shown, the computer program 612 includes the selection module 628. For example, the selection module 628 can be in the form of instructions stored on a non-transitory computer-readable storage medium. The non-transitory computer-readable storage medium having the instructions that, when executed by the computing system 602, causes the computing system 602 to perform the one or more methods described in FIGS. 1 and 5.

In one embodiment, the selection module 628 selects 1D elements in the FEM of the source FEA tool 632 are selected based on associated physical behavioral features. Further, the selection module 628 extracts shear stiffness factors associated with each selected 1D element in the FEM of the source FEA tool. Furthermore, the selection module 628 selects the equivalent 1D element type in the FEM of the destination FEA tool 630 for each selected 1D element in the FEM of the source FEA tool 632 based on the extracted shear stiffness factors for performing FEA. This is explained in more detail with reference to FIGS. 1 and 5.

In various embodiments, the systems and methods described in FIGS. 1 through 6 propose a technique for selecting an equivalent 1D element type in a destination FEA tool corresponding to each 10D element of a source FEA tool. In other words, the the systems and methods described in FIGS. 1 through 6 propose a technique for selecting the equivalent 1D element type in the destination FEA tool by capturing correct physical behavioral features.

Although certain methods, systems, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method for selection of an equivalent one dimension (1D) element type in a finite element model (FEM) of a destination finite element analysis (FEA) tool corresponding to each 1D element in a FEM of a source FEA tool for performing FEA, comprises:
selecting 1D elements in the FEM of the source FEA tool based on associated physical behavioral features;
extracting shear stiffness factors associated with each selected 1D element in the FEM of the source FEA tool; and
selecting the equivalent 1D element type in the FEM of the destination FEA tool corresponding to each selected 1D element in the FEM of the source FEA tool based on the extracted shear stiffness factors for performing FEA.

2. The method of claim 1, wherein the physical behavioral features are selected from the group consisting of axial stiffness, torsional stiffness, bending stiffness, transverse shear stiffness, a shear centre offset, a neutral axis offset, warping, stress recovery, variable cross-sectional properties along length, release translational degree of freedom (DOF) at end nodes of a 1D element, release rotational DOF at end nodes of a 1 D element and a number of nodes in a 1D element.

3. The method of claim 1, wherein extracting the shear stiffness factors associated with each selected 1D element in the FEM of the source FEA tool, comprises:
extracting a first shear stiffness factor (K1) associated with each selected 1D element corresponding to an XY plane; and
extracting a second shear stiffness factor (K2) associated with each selected 1D element corresponding to an XZ plane.

4. The method of claim 3, wherein selecting the equivalent 1D element type in the FEM of the destination FEA tool corresponding to each selected 1D element in the FEM of the source FEA tool based on the extracted shear stiffness factors, comprises:
when K1 and K2 associated with one of the selected 1D elements of the source FEA tool are simultaneously equal to zero or infinity,
selecting a set of 1D element types having no transverse shear stiffness in the destination FEA tool;
allowing a user to select a type of FEA to be performed in the destination FEA tool; and
selecting the equivalent 1D element type from the set of 1D element types corresponding to the one of the selected 1D elements based on the selected type of FEA to be performed in the destination FEA tool.

5. The method of claim 4, wherein the type of FEA to be performed in the destination FEA tool is selected from the group consisting of a linear FEA and a non-linear FEA.

6. The method of claim 4, wherein selecting the equivalent 1D element type in the FEM of the destination FEA tool corresponding to each selected 1D element in the FEM of the source FEA tool based on the extracted shear stiffness factors, comprises:
when at least one of K1 and K2 associated with the one of the selected 1D elements is greater than zero,
selecting a set of 1D element types having transverse shear stiffness in the destination FEA tool;
allowing the user to select a preference for the equivalent 1D element type and a solver in the destination FEA tool; and
selecting the equivalent 1D element type from the set of 1D element types corresponding to the one of the selected 1D elements based on the selected preference for the equivalent 1D element type and the solver in the destination FEA tool.

7. The method of claim 6, further comprising:
repeating the steps of claim 4 or claim 6 for remaining selected 1D elements of the source FEA tool based the extracted shear stiffness factors associated with the remaining selected 1D elements.

8. The method of claim 6, wherein the preference for the equivalent 1D element type is selected from the group consisting of a two-node 1D element type and a three-node 1D element type.

9. The method of claim 1, further comprising:
converting each selected 1D element in the FEM of the source FEA tool to the FEM of the destination FEA tool using the selected equivalent 1D element type corresponding to each selected 1D element.

10. A system comprising:
a processor; and
a memory coupled to the processor, wherein the memory includes:
a source finite element analysis (FEA) tool;
a destination FEA tool; and
a selection module configured to:
select one dimension (1D) elements in a finite element model (FEM) of the source FEA tool based on associated physical behavioral features;
extract shear stiffness factors associated with each selected 1D element in the FEM of source FEA tool; and
select an equivalent 1D element type in a FEM of the destination FEA tool corresponding to each selected 1D element in the FEM of the source FEA tool based on the extracted shear stiffness factors for performing FEA.

11. The system of claim 10, wherein the physical behavioral features are selected from the group consisting of axial stiffness, torsional stiffness, bending stiffness, transverse shear stiffness, a shear centre offset, a neutral axis offset, warping, stress recovery, variable cross-sectional properties along length, release translational DOF at end nodes of a 1D element, release rotational DOF at end nodes of a 1D element and a number of nodes in a 1D element.

12. The system of claim 10, wherein the selection module is configured to:
extract a first shear stiffness factor (K1) associated with each selected 1D element corresponding to an XY plane; and
extract a second shear stiffness factor (K2) associated with each selected 1D element corresponding to an XZ plane.

13. The system of claim 12, wherein the selection module is configured to:
select a set of 1D element types having no transverse shear stiffness in the destination FEA tool when K1 and K2 associated with one of the selected 1D elements of the source FEA tool are simultaneously equal to zero or infinity;
allow a user to select a type of FEA to be performed in the destination FEA tool; and
select the equivalent 1D element type from the set of 1D element types corresponding to the one of the selected 1D elements based on the selected type of FEA to be performed in the destination FEA tool.

14. The system of claim 13, wherein the type of FEA to be performed in the destination FEA tool is selected from the group consisting of a linear FEA and a non-linear FEA.

15. The system of claim 13, wherein the selection module is configured to:
select a set of 1D element types having transverse shear stiffness in the destination FEA tool when at least one of K1 and K2 associated with the one of the selected 1D elements is greater than zero;
allow the user to select a preference for the equivalent 1D element type and a solver in the destination FEA tool; and
select the equivalent 1D element type from the set of 1D element types corresponding to the one of the selected 1D elements based on the selected preference for the equivalent 1D element type and the solver in the destination FEA tool.

16. The system of claim 15, wherein the selection module is further configured to:
repeat the steps of claim 13 or claim 15 for remaining selected 1D elements of the source FEA tool based on the extracted shear stiffness factors associated with the remaining selected 1D elements.

17. The system of claim 15, wherein the preference for the equivalent 1D element type is selected from the group consisting of a two-node 1D element type and a three-node 1D element type.

18. A non-transitory computer-readable storage medium including instructions that are configured, when executed by a computing device, to perform a method for selection of an equivalent one dimension (1D) element type in a finite element model (FEM) of a destination finite element analysis (FEA) tool corresponding to each 1D element in a FEM of a source FEA tool for performing FEA, the method comprising:
selecting 1D elements in the FEM of the source FEA tool based on associated physical behavioral features;
extracting shear stiffness factors associated with each selected 1D element in the FEM of the source FEA tool; and
selecting the equivalent 1D element type in the FEM of the destination FEA tool corresponding to each selected 1D element in the FEM of the source FEA tool based on the extracted shear stiffness factors for performing FEA.

19. The non-transitory computer storage medium of claim 18, wherein the physical behavioral features are selected from the group consisting of axial stiffness, torsional stiffness, bending stiffness, transverse shear stiffness, a shear centre offset, a neutral axis offset, warping, stress recovery, variable cross-sectional properties along length, release translational DOF at end nodes of a 1D element, release rotational DOF at end nodes of a 1D element and a number of nodes in a 1D element.

20. The non-transitory computer storage medium of claim 18, wherein extracting the shear stiffness factors associated with each selected 10D element in the FEM of the source FEA tool, comprises:
extracting a first shear stiffness factor (K1) associated with each selected 1D element corresponding to an XY plane; and
extracting a second shear stiffness factor (K2) associated with each selected 1D element corresponding to an XZ plane.

21. The non-transitory computer storage medium of claim 20, wherein selecting the equivalent 1D element type in the FEM of the destination FEA tool corresponding to each selected 1D element in the FEM of the source FEA tool based on the extracted shear stiffness factors, comprises:
selecting a set of 1D element types having no transverse shear stiffness in the destination FEA tool when K1 and K2 associated with one of the selected 1D elements of the source FEA tool are simultaneously equal to zero or infinity;
allowing a user to select a type of FEA to be performed in the destination FEA tool; and
selecting the equivalent 1D element type from the set of 1D element types corresponding to the one of the selected 1D elements based on the selected type of FEA to be performed in the destination FEA tool.

22. The non-transitory computer storage medium of claim 21, wherein the type of FEA to be performed in the destination FEA tool is selected from the group consisting of a linear FEA and a non-linear FEA.

23. The non-transitory computer storage medium of claim 21, wherein selecting the equivalent 1D element type in the FEM of the destination FEA tool corresponding to each selected 1D element in the FEM of the source FEA tool based on the extracted shear stiffness factors, comprises:
selecting a set of 1D element types having transverse shear stiffness in the destination FEA tool when at least one of K1 and K2 associated with the one of the selected 1D elements is greater than zero;
allowing the user to select a preference for the equivalent 1D element type and a solver in the destination FEA tool; and
selecting the equivalent 1D element type from the set of 1D element types corresponding to the one of the selected 1D elements based on the selected preference for the equivalent 1D element type and the solver in the destination FEA tool.

24. The non-transitory computer storage medium of claim 23, further comprising:
repeating the steps of claim 21 or claim 23 for remaining selected 1D elements of the source FEA tool based on the extracted shear stiffness factors associated with the remaining selected 1D elements.

25. The non-transitory computer storage medium of claim 23, wherein the preference for the equivalent 1D element type is selected from the group consisting of a two-node 1D element type and a three-node 1D element type.
